(19) United States
(12) Patent Application Publication
(10) Pub. No.: US 2026/0349104 A1
(43) Pub. Date: Nov. 5, 2026

(54) REPEATER NODE ASSISTED SENSING OF AN OBJECT

(71) Applicant: Telefonaktiebolaget LM Ericsson (publ), Stockholm (SE)

(72) Inventors: Behrooz MAKKI, Pixbo (SE); Magnus ÅSTRÖM, Lund (SE); Andreas NILSSON, Göteborg (SE)

(73) Assignee: Telefonaktiebolaget LM Ericsson (publ), Stockholm (SE)

(21) Appl. No.: 19/477,848

(22) PCT Filed: Apr. 27, 2023
(86) PCT No.: PCT/EP2023/061196

§ 371 Date: Oct. 23, 2025

(51) Int. Cl. G01S 13/76; G01S 7/00; G01S 13/02; G01S 13/87; G01S 13/91; G01S 13/931

(52) U.S. Cl. CPC G01S 13/762; G01S 7/006; G01S 13/765; G01S 13/767; G01S 13/872; G01S 13/91; G01S 13/931; G01S 2013/0245

(57) ABSTRACT

There is provided techniques for performing repeater node assisted sensing of an object. A method performed by a network node comprises configuring a repeater node for the sensing of the object. The method comprises wirelessly transmitting at least one sensing signal. The at least one sensing signal is transmitted towards the object, and/or towards the repeater node for is reflected towards the object. The method comprises wirelessly receiving at least one reflection signal. The at least one reflection signal is a reflection of the at least one sensing signal as reflected at the object. The method comprises sensing at least one of location, direction of movement, speed of movement, of the object by processing the at least one reflection signal.

### TECHNICAL FIELD

Embodiments presented herein relate to methods, a network node, a repeater node, computer programs, and a computer program product for performing repeater node assisted sensing of an object.

### BACKGROUND

Some wireless communication networks provide sensing services in diverse application areas, such as detection, ranging and tracking of vulnerable road users, automated guided vehicles, or unmanned aerial vehicles. Sensing can help to improve the position estimation of both active and passive objects. For active objects, whose positions are estimated using cellular signals sensing can be used as a means to make the position estimation more precise, while for passive objects sensing can either be the sole available scheme for determining its position, or sensing data can be fused by data provided by other sensors, such as inertial measurement unit (IMU), onboard light detection and ranging (LIDAR) device, etc.

One objective with joint communication and sensing (JCS) is to share the spectrum efficiently between wireless communication and sensing and/or reuse the existing wireless network infrastructure for sensing. In other words, JCS refers to the introduction of sensing capability as part of a wireless communication networks. Here, sensing refers to radar-like functionalities, i.e., the ability to detect the presence, the movement, and the other characteristics of an objects that is under the coverage of a wireless network. Compared to the deployment of a separate network for sensing functionality, one benefit of JCS is that the sensing capability can be introduced on large scale at a relatively low incremental cost by reusing the infrastructure that is deployed for communication purposes. In general terms, sensing involves transmitting a sensing signal towards the object to be sensed, and receiving a reflection of the sensing signal, which is then processed,

For mono-static sensing the transmission of the sensing signal and the reception of the reflected sensing signal are handled by the same node.

For multi-static sensing, the transmission and the reception can be handled by different collaborating nodes. One common type of multi-static sensing is bi-static sensing where one node transmits the sensing signal and another node receives the reflection of the sensing signal.

Mono-static sensing typically requires full duplex capability at the node performing the sensing. This is intuitively because in a typical sensing scenario the sensing range may be in the order of tens to hundreds of meters and, thereby, the reflected wave may be received within a fraction of a microseconds which is shorter than in typical data communication systems with larger time scales (in the order of tens of microseconds). Full duplex, however, may be challenging as it requires high level of self-interference cancellation. With bi-static (or, in general multi-static) sensing, on the other hand, full duplex is not required as the signal is transmitted and received by different nodes.

Due to issues with full duplex operation in current wireless networks, mono-static sensing will be challenging for current network equipment (such as network nodes, user equipment, network-controlled repeaters, etc.) and instead bi-static sensing might become more common in communication networks, where one node (such as a network node) is transmitting the sensing signal, and another node (such as another network node, or a user equipment) receives the reflected sensing signal.

However, current technology does not provide any means for how to use, or integrate, different types of repeaters, or similar pieces of network equipment, in the context of JCS.

### SUMMARY

An object of embodiments herein is to address the above issues.

A particular object is to enable sensing of objects without having to deploy extra regular transmission and reception points for this purpose.

A particular object is to enable different types of repeaters, or similar pieces of network equipment, to be used or integrated in the context of JCS.

According to a first aspect there is presented a method for performing repeater node assisted sensing of an object. The method is performed by a network node. The method comprises configuring a repeater node for the sensing of the object. The method comprises wirelessly transmitting at least one sensing signal. The at least one sensing signal is transmitted towards the object, and/or towards the repeater node for is reflected towards the object. The method comprises wirelessly receiving at least one reflection signal. The at least one reflection signal is a reflection of the at least one sensing signal as reflected at the object. The at least one reflection signal is received from the repeater node when the at least one sensing signal was transmitted towards the object or when the at least one sensing signal was transmitted towards the repeater node. The at least one reflection signal is received from the object when the at least one sensing signal was transmitted towards the repeater node. The method comprises sensing at least one of location, direction of movement, speed of movement, of the object by processing the at least one reflection signal.

According to a second aspect there is presented anetwork node for performing repeater node assisted sensing of an object. The network node comprises processing circuitry. The processing circuitry is configured to cause the network node to configure a repeater node for the sensing of the object. The processing circuitry is configured to cause the network node to wirelessly transmit at least one sensing signal. The at least one sensing signal is transmitted towards the object, and/or towards the repeater node for is reflected towards the object. The processing circuitry is configured to cause the network node to wirelessly receive at least one reflection signal.

The at least one reflection signal is a reflection of the at least one sensing signal as reflected at the object. The at least one reflection signal is received from the repeater node when the at least one sensing signal was transmitted towards the object or when the at least one sensing signal was transmitted towards the repeater node. The at least one reflection signal is received from the object when the at least one sensing signal was transmitted towards the repeater node. The processing circuitry is configured to cause the network node to sense at least one of location, direction of movement, speed of movement, of the object by processing the at least one reflection signal.

According to a third aspect there is presented a network node for performing repeater node assisted sensing of an object. The network node comprises a configure module) configured to configure a repeater node for the sensing of the object. The network node comprises a transmit module configured to wirelessly transmit at least one sensing signal. The at least one sensing signal is transmitted towards the object, and/or towards the repeater node for is reflected towards the object. The network node comprises a receive module configured to wirelessly receive at least one reflection signal. The at least one reflection signal is a reflection of the at least one sensing signal as reflected at the object. The at least one reflection signal is received from the repeater node when the at least one sensing signal was transmitted towards the object or when the at least one sensing signal was transmitted towards the repeater node. The at least one reflection signal is received from the object when the at least one sensing signal was transmitted towards the repeater node. The network node comprises a sense module configured to sense at least one of location, direction of movement, speed of movement, of the object by processing the at least one reflection signal.

According to a fourth aspect there is presented a computer program for performing repeater node assisted sensing of an object. The computer program comprises computer code which, when run on processing circuitry of a network node, causes the network node to perform actions. One action comprises the network node to configure a repeater node for the sensing of the object. One action comprises the network node to wirelessly transmit at least one sensing signal. The at least one sensing signal is transmitted towards the object, and/or towards the repeater node for is reflected towards the object. One action comprises the network node to wirelessly receive at least one reflection signal. The at least one reflection signal is a reflection of the at least one sensing signal as reflected at the object. The at least one reflection signal is received from the repeater node when the at least one sensing signal was transmitted towards the object or when the at least one sensing signal was transmitted towards the repeater node. The at least one reflection signal is received from the object when the at least one sensing signal was transmitted towards the repeater node. One action comprises the network node to sense at least one of location, direction of movement, speed of movement, of the object by processing the at least one reflection signal.

According to a fifth aspect there is presented a method for performing repeater node assisted sensing of an object. The method is performed by a repeater node. The method comprises obtaining configuration, from a network node, for the sensing of the object. The method comprises performing the repeater node assisted sensing of the object by reflecting/forwarding at least one sensing signal, as wirelessly received from the network node, towards the object and/or reflecting/forwarding at least one reflection signal, as wirelessly received from the object, towards the network node.

According to a sixth aspect there is presented a repeater node for performing repeater node assisted sensing of an object. The repeater node comprises processing circuitry. The processing circuitry is configured to cause the repeater node to obtain configuration, from a network node, for the sensing of the object. The processing circuitry is configured to cause the repeater node to perform the repeater node assisted sensing of the object by reflecting/forwarding at least one sensing signal, as wirelessly received from the network node, towards the object and/or reflecting/forwarding at least one reflection signal, as wirelessly received from the object, towards the network node.

According to a seventh aspect there is presented a repeater node for performing repeater node assisted sensing of an object. The repeater node comprises an obtain module configured to obtain configuration, from a network node, for the sensing of the object. The repeater node comprises a sense module configured to perform the repeater node assisted sensing of the object by reflecting/forwarding at least one sensing signal, as wirelessly received from the network node, towards the object and/or reflecting/forwarding at least one reflection signal, as wirelessly received from the object, towards the network node.

According to an eighth aspect there is presented a computer program for performing repeater node assisted sensing of an object. The computer program comprises computer code which, when run on processing circuitry of a repeater node, causes the repeater node to perform actions. One action comprises the repeater node to obtain configuration, from a network node, for the sensing of the object. One action comprises the repeater node to perform the repeater node assisted sensing of the object by reflecting/forwarding at least one sensing signal, as wirelessly received from the network node, towards the object and/or reflecting/forwarding at least one reflection signal, as wirelessly received from the object, towards the network node.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects address the above issues.

Advantageously, these aspects enable sensing of objects without having to deploy extra regular transmission and reception points for this purpose.

Advantageously, these aspects enable different types of repeaters, or similar pieces of network equipment, to be used or integrated in the context of JCS.

Advantageously, these aspects provide efficient sensing schemes using repeater nodes. In this way, the presence of the repeater node helps to improve the accuracy for sensing the object's position, direction and speed, and avoid sensing holes where the network node alone cannot properly sense the object. This is a low complexity and cost-efficient scheme where the existing infrastructure is used to detect the presence, movement, and other characteristics of the objects under the coverage of the wireless network and obtain a better understanding about the general characteristics of the environment.

Advantageously, these aspects enable the network node to be informed about the capabilities and architecture of the repeater nodes for sensing and, accordingly, the network node is able to configure the repeater nodes for sensing actions. This will give the chance to the network node to have a better view on the surrounding area and sense the objects' location, direction and/or speed with high accuracy.

Advantageously, this, in turn, will improve the versatility and quality of the wireless sensing and thereby, indirectly, also the communication.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic illustration of sensing of object without and with assistance of a repeater node according to embodiments;

FIG. 2 is a schematic diagram illustrating a communication network according to embodiments;

FIG. 3 is a schematic illustration of a repeater node implemented as a network-controlled repeater according to an embodiment;

FIG. 4 is a schematic illustration of a repeater node implemented as a RIS node according to an embodiment;

FIGS. 5 and 6 are flowcharts of methods according to embodiments;

FIG. 7 is a schematic illustration of transmission and reception of sensing signals for sensing an object according to an embodiment;

FIGS. 8, 9, and 10 are block diagrams of repeater nodes according to embodiments;

FIG. 11 is a schematic diagram showing functional units of a network node according to an embodiment;

FIG. 12 is a schematic diagram showing functional modules of a network node according to an embodiment;

FIG. 13 is a schematic diagram showing functional units of a repeater node according to an embodiment;

FIG. 14 is a schematic diagram showing functional modules of a repeater node according to an embodiment; and

FIG. 15 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, using regular transmission and reception points for the sensing is expensive since this requires many transmission and reception points to be deployed. Further, this also is cumbersome since this requires coordination between the transmission and reception points.

According to the herein disclosed embodiments, one or more repeater nodes (with examples as provided below) can be utilized to improve the location, the speed and the direction estimation for the objects that are sensed. Here, the repeater nodes are properly configured by the controlling network node to receive and/or transmit sensing signals in one or more time and/or frequency resources.

The embodiments disclosed herein in particular relate to techniques for performing repeater node assisted sensing of an object. In order to obtain such techniques there is provided a network node, a method performed by the network node, a computer program product comprising code, for example in the form of a computer program, that when run on processing circuitry of the network node, causes the network node to perform the method. In order to obtain such techniques there is further provided a repeater node, a method performed by the repeater node, and a computer program product comprising code, for example in the form of a computer program, that when run on processing circuitry of the repeater node, causes the repeater node to perform the method.

In general terms, radar and wireless communications technologies, both based on electromagnetic wave propagation, have been key technologies during the last decades although with little interaction with each other. Here, most efforts have been on enabling the coexistence of these technologies with little interference to each other. This has been made possible by, for instance, considering different bandwidths for wireless communication and radar. However, with fifth-generation (5G) telecommunication systems and beyond, wireless communication is moving towards the range of frequencies which were previously used by radars. For instance, some of the radar bands, such as band K (18 GHz-26.5 GHz) and band Ka (26.5 GHz-40 GHz) are close to or may even overlap mmWave communication bands, e.g., 28 GHz and 39 GHz. This may cause conflicts and requires coordination. At the same time, sensing is expected to play an important role in, e.g., smart cities, automation, autonomous derive, active safety, etc. Satisfying such huge sensing requirements will be challenging. These are some motivations for JCS systems in which the wireless communication infrastructure and/or spectrum is used to enable sensing functionalities. In this way, not only the conflicts between the sensing and wireless communication functionalities are minimized via coordination but also the implementation cost will be reduced because the sensing functionalities can be performed by reusing the wireless communication infrastructure.

In general, sensing accuracy can be improved by sensing an object from different perspectives and/or directions. Particularly, depending on the object's location and moving direction, there may be sensing holes where the network node alone may not be able to detect the object. For instance, if the object is moving perpendicularly to the network node (i.e., when the Doppler shift of the line-of-sight signal is zero), it is difficult for the network node to detect the object at all. In another scenario, the reflections of the sensing signal as caused by the object may be ill-suited to be received by the same node as transmitted the sensing signal, since the sensing signal might be predominantly reflected elsewhere. In such cases, it would be useful to have radar-like measurements from another direction as well. One option to have the second view on the objects it to use the existing network nodes assisting the macro base stations (BSs), e.g., relays, integrated access and network (IAB) nodes, etc. Thus, multiple sensing views of an object can be obtained if such nodes are sensing-capable. However, in many cases, for instance the IABs, the nodes are already quite complex and expensive, and it may not be practically possible to add yet another set of functionalities to them.

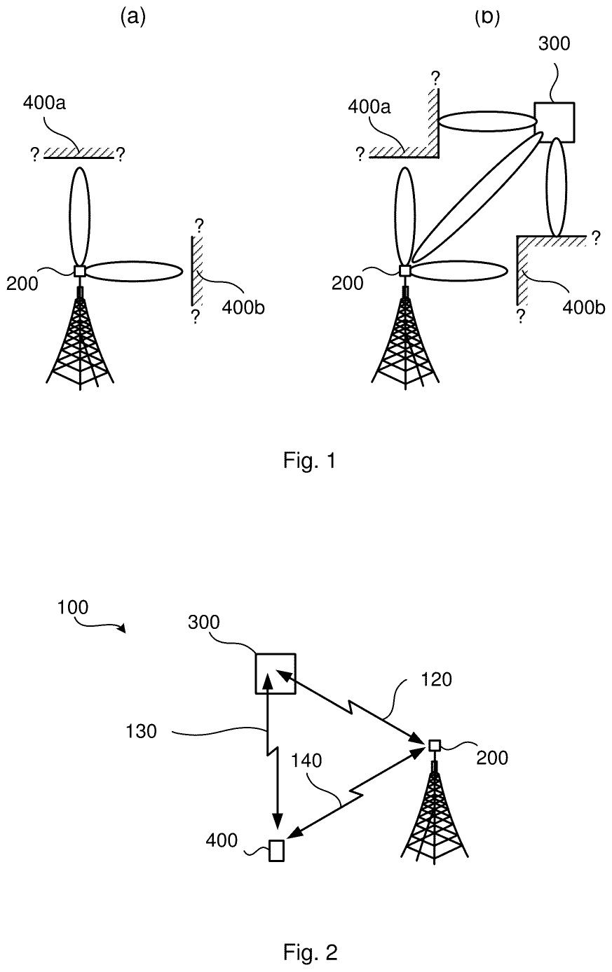

FIG. 1 illustrates an example where an additional repeater node 300 can be used to aid a network node 200 to attain more accurate sensing of its surrounding environment, as represented by objects 400a, 400b. In FIG. 1(a) is illustrated the situation without any extra repeater node. As illustrated, the network node 200 can transmits sensing signals in different beams towards the objects 400a, 400b, and by means of receiving a reflection of the sensing signal, as reflected by the objects 400a, 400b, the network node 200 can obtain some information about its environment. But it might be difficult for the network node 200 to estimate how far the objects 400a, 400b extend. This is illustrated by question marks “?”. In FIG. 1(b) is illustrated the situation with one extra repeater node 300. As illustrated, the network node 200 can transmit a sensing signal towards the repeater node 300 which then reflects or forwards (depending on the configuration of the repeater node 300) the sensing signal towards the objects 400a, 400b for reflection either back directly to the network node 200 or back to the network node 200 via the repeater node 300. As compared to the situation in FIG. 1(a), a more accurate sensing of the environment can thus be attained with the extra repeater node 300 since the environment can be sensed from two different directions. The presence of the repeater node 300 may thus make it possible for the network node 200 to attain a more complete view of the environment. This is in FIG. 1(b) illustrated by the contours of the objects 400a, 400b having been extended and thus that the question marks have been moved compared to FIG. 1(a).

The repeater node can be regarded as logically be part of the network node for all management purposes. Depending on the capabilities and the architecture of the repeater node, the repeater node might be capable of amplifying-and-forwarding, or only reflecting, sensing signals with accurate, possibly narrow, beamforming and negligible/known delay. Thus, depending on the capabilities and the architecture of the repeater node, the repeater node can be used to provide the network node with a further view of an object to be sensed, thereby to improve the sensing quality and/or avoid, or at least reduce, possible sensing holes.

This is one motivation for introducing repeater nodes that can be integrated and configured by the network nodes. In general terms, the presence of one or more repeater nodes might facilitate bi-static, or in general multi-static, sensing.

Further reference is here made to the communications network 100 in FIG. 2 where embodiments presented herein can be applied. The communications network 100 comprises a network node 200 and a repeater node 300. The network node 200 and the repeater node 300 communicate over a wireless link 120. A sensing signal transmitted over a wireless link 140 from the network node 200 can be reflected by an object 400 and received by the repeater node 300 over a wireless link 130. Likewise, a sensing signal transmitted over the wireless link 130 from the repeater node 300 can be reflected by the object 400 and received by the network node 200 over the wireless link 140. In some examples, the network node 200 is any of a (radio) access network node, radio base station, base transceiver station, node B (NB), evolved node B (eNB), gNB, access point, access node, IAB node. In some aspects, the repeater node 300 is a network-controlled repeater or a reconfigurable intelligent surface (RIS) node.

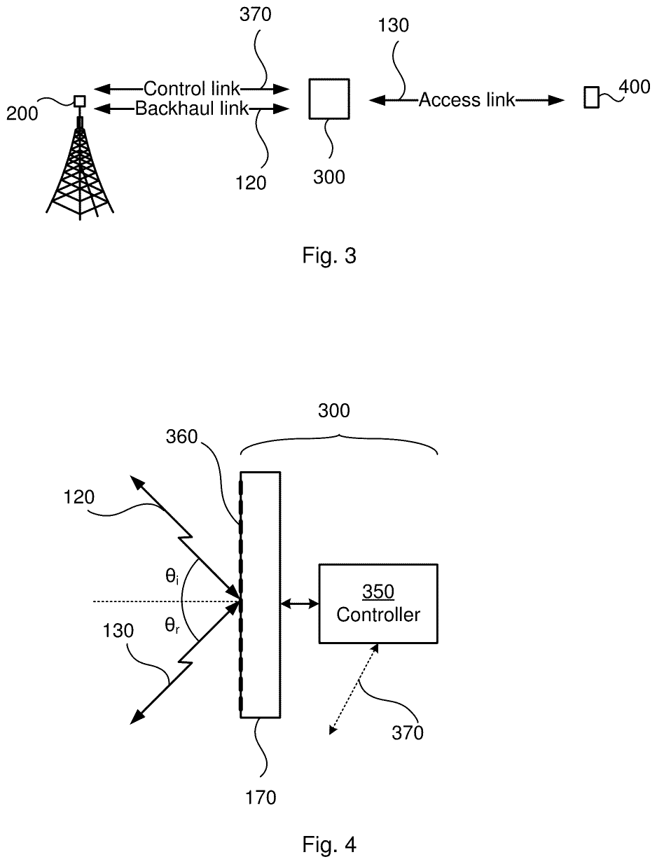

An example where the repeater node 300 is a network-controlled repeater will be disclosed next with reference to FIG. 3. In this example, the functionality of the repeater node is provided in a network-controlled repeater with beamforming capabilities. In this way, the repeater node 300 could be considered as a network-controlled beam bender when compared to a proper network node, such as a gNB. As such, the network-controlled repeater is logically part of the network node for all management purposes. In this way the network-controlled repeater can be deployed and be under the control of the same mobile network operator as the mobile network operator of the network node 200. In some examples, the network-controlled repeater is based on an amplify-and-forward relaying scheme. In other words, the network-controlled repeater with the herein disclosed functionality can be regarded as an enhancement over conventional radio-frequency repeaters with the capability to receive and process side control information from the network node as well as performing accurate beamforming. Side control information could allow the network-controlled repeater to perform an amplify-and-forward operation of a sensing signal in a more efficient manner with narrow beams. As illustrated in FIG. 3, the repeater node 300, when being implemented as a network-controlled repeater, is configured to maintain a control link 370 to the network node 200 for receiving configuration from the network node 200 and for providing reports to the network node 200. As further illustrated, a sensing signal as transmitted by the network node 200 is received over a backhaul link 120 and forwarded over an access link 130 towards the object 400. Further, a reflection of the sensing signal is received over the access link 130 and forwarded towards the network node 200 over the backhaul link 120. For this purpose, the network node 300 might implement a network-controlled repeater mobile termination (NCR-MT) interface for signalling over the control link 370 and a network-controlled repeater forwarding (NCR-FW) interface for signalling over the backhaul link 120 and the access link 130. Operational behavior of the NCR-FW interface might be configured according to information, configurations, or settings as received over the NCR-MT interface from the network node 200.

An example where the repeater node 300 is a RIS node will be disclosed next with reference to FIG. 4. In general terms, a RIS node is capable of intelligently manipulating the propagation of electro-magnetic waves. The RIS is composed of a 2-dimensional array 170 of reflecting elements 360, where each element acts as a passive reconfigurable scatterer, i.e., a piece of manufactured material, which can be programmed to change an impinging electro-magnetic wave in a customizable way. Such elements are usually low-cost passive surfaces that do not require dedicated power sources, and the radio waves (as here represented by signals on the links 120, 130) impinged upon them can be reflected without the need of employing power amplifier or radio-frequency chain. Moreover, a RIS node can, potentially, operate in full duplex mode without significant self-interference or increased noise level and require only low-rate control link or backhaul connections. The RIS node comprises a controller 350 that is configured to change the settings of the elements 360 to thereby change how an impinging electro-magnetic wave is reflected (in terms of direction, beamforming, etc.). In this respect, the controller 350 receives information, configurations, or settings from the network node 200 over a control link 370. A RIS node can be flexibly deployed due to its low weight and low power consumption. A RIS node can be regarded as a network-controlled repeater but with no, or even negative, amplification. That is, the RIS node might be capable of signal reflection via adapting a phase matrix for tuning the elements 360 whilst the network-controlled repeater is capable also of power amplification. Further, because the RIS node only reflects incoming signals, it might have lower internal, or processing, delay, than the network-controlled repeater.

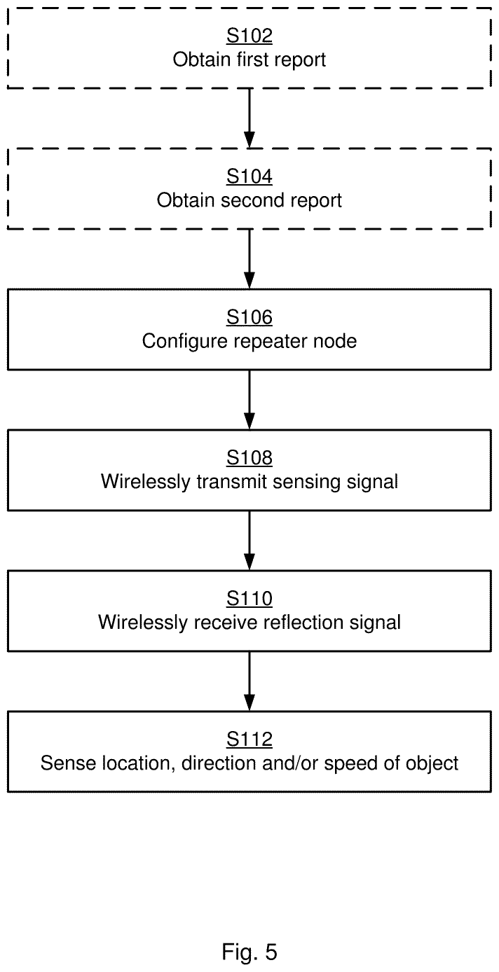

Reference is now made to FIG. 5 illustrating a method for performing repeater node assisted sensing of an object 400, 400a, 400b as performed by the network node 200 according to an embodiment.

S106: The network node 200 configures a repeater node 300, 300a, 300b for the sensing of the object 400, 400a, 400b. In some embodiments, the repeater node 300, 300a, 300b is either a network-controlled repeater or a reconfigurable intelligent surface node. Different examples of configurations will be disclosed below.

The configuration might be a dynamic, semi-static or semi-persistent configuration. The configuration might be sent using radio resource control (RRC) signaling, medium access control (MAC) control element (CE) signaling, or downlink control information (DCI) signaling.

S108: The network node 200 wirelessly transmits at least one sensing signal. The at least one sensing signal is transmitted towards the object 400, 400a, 400b, and/or towards the repeater node 300, 300a, 300b for being reflected towards the object 400, 400a, 400b.

S110: The network node 200 wirelessly receives at least one reflection signal. The at least one reflection signal is a reflection of the at least one sensing signal as reflected at the object 400, 400a, 400b.

The at least one reflection signal is received from the repeater node 300, 300a, 300b when the at least one sensing signal was transmitted towards the object 400, 400a, 400b or when the at least one sensing signal was transmitted towards the repeater node 300, 300a, 300b.

The at least one reflection signal is received from the object 400, 400a, 400b, or from a further repeater node 300, 300a, 300b, when the at least one sensing signal was transmitted towards the repeater node 300, 300a, 300b.

S112: The network node 200 senses at least one of: location, direction of movement, speed of movement, of the object 400, 400a, 400b by processing the at least one reflection signal.

Embodiments relating to further details of performing repeater node assisted sensing of an object 400, 400a, 400b as performed by the network node 200 will now be disclosed with continued reference to FIG. 5.

Embodiments relating to different ways in which the network node 200 might configure the repeater node 300, 300a, 300b will now be described in turn.

In some embodiments, configuring the repeater node 300, 300a, 300b comprises configuring the repeater node 300, 300a, 300b with one or more time resources for wireless transmission and/or reception (of sensing signals). In some embodiments, configuring the repeater node 300, 300a, 300b comprises configuring the repeater node 300, 300a, 300b for at least one of: reflecting/forwarding the at least one sensing signal towards the object 400, 400a, 400b, reflecting/forwarding the at least one reflection signal towards the network node 200. In this respect, whether the repeater node 300, 300a, 300b reflects or forwards the at least one reflection signal generally depends on the capability of the repeater node 300, 300a, 300b. For example, repeater nodes 300, 300a, 300b in terms of network-controlled repeaters might be capable of forwarding received sensing signals whereas repeater nodes 300, 300a, 300b in terms of RIS nodes might only be capable of reflecting sensing signals.

In some aspects, the configuration indicates at which time instance the repeater node 300, 300a, 300b should switch from uplink operation to downlink operation, and vice versa. Hence, in some embodiments, configuring the repeater node 300, 300a, 300b comprises indicating time instances at which the repeater node 300, 300a, 300b is switched from reflecting/forwarding the at least one sensing signal towards the object 400, 400a, 400b to reflecting/forwarding the at least one reflection signal towards the network node 200, and/or indicating time instances at which the repeater node 300, 300a, 300b is switched from reflecting/forwarding the at least one reflection signal towards the network node 200 to reflecting/forwarding the at least one sensing signal towards the object 400, 400a, 400b. This configuration can be used when the repeater node 300, 300a, 300b has indicated support for both uplink operation and downlink operation.

In some aspects, the configuration indicates how the repeater node 300, 300a, 300b should alternate the polarization for the transmitter and/or receiver for the time slot that the repeater node 300, 300a, 300b is used for sensing. Therefore, in some embodiments, configuring the repeater node 300, 300a, 300b comprises indicating polarization to be used when reflecting/forwarding the at least one sensing signal towards the object 400, 400a, 400b and/or when reflecting/forwarding the at least one reflection signal towards the network node 200. This configuration can be used when the repeater node 300, 300a, 300b has indicated support for alternating polarization for sensing.

Multiple repeater nodes 300, 300a, 300b may be used for sensing the same object, effectively providing multi-dimensional sensing. In some aspects, more than one repeater node 300, 300a, 300b is therefore configured for the sensing. That is, in some embodiments, the repeater node is a first repeater node 300a, and also a second repeater node 300b is configured for the sensing of the object 400, 400a, 400b.

In this way, the network node 200 may transmit a sensing signal via a first repeater node 300, 300a, 300b and receive the sensing signal via a second repeater node 300, 300a, 300b. In some aspects, the network node 200 therefore configures a first repeater node 300, 300a, 300b for downlink operation and a second repeater node 300, 300a, 300b for uplink operation. Then, transmitting the at least one sensing signal might imply transmitting a signal towards the first repeater node 300, 300a, 300b, and receiving at least one reflection of the sensing signal might imply receiving at least one reflected of the signal from the second repeater node 300, 300a, 300b. Particularly, in some embodiments, the at least one sensing signal is transmitted towards the first repeater node 300, 300a, 300b for being reflected towards the object 400, 400a, 400b. The at least one reflection signal is received from the second repeater node 300, 300a, 300b.

Regardless if there is one repeater node 300, 300a, 300b or two or more repeater nodes 300, 300a, 300b, the network node 200 might wirelessly transmit at least two sensing signals.

The at least two sensing signals might be multiplexed in time, frequency, space, and/or polarization. That is, in some embodiments, the at least two sensing signals are multiplexed using any, or any combination, of: time-division multiplexing, frequency-division multiplexing, space-division multiplexing, polarization multiplexing.

In order to enable certain sensing use cases, or to improve accuracy in the sensing, two different sensing signals which are received by the network node 200 from different directions can be used. As an example, one sensing signal can be sent from the network node 200 and be reflected back to the network node 200 directly from the object, and another sensing signal can also be transmitted by the network node 200 but be received by the network node 200 after reflection at the object and via the repeater node 300, 300a, 300b. In some embodiments, a first of the at least two sensing signals is transmitted towards the object 400, 400a, 400b, and a second of the at least two sensing signals is transmitted towards the repeater node 300, 300a, 300b for being reflected towards the object 400, 400a, 400b. A first reflection signal, being the reflection of the first sensing signal as reflected at the object 400, 400a, 400b, is received from the repeater node 300, 300a, 300b, and a second reflection signal, being the reflection of the second sensing signal as reflected at the object 400, 400a, 400b, is received from the object 400, 400a, 400b.

In some aspects, the sensing signal is transmitted in multiple beams at the network node 200 and/or reflected/forwarded in multiple beams at the repeater node 300, 300a, 300b. In particular, in some embodiments, one occurrence of the at least one sensing signal is transmitted in each beam in a first set of directional beams, and/or the repeater node 300, 300a, 300b is configured to reflect/forward one occurrence of the at least one sensing signal towards the object 400, 400a, 400b in each beam in a second set of directional beams. Hence, multiple transmit beams can be used by the network node 200 for sending the sensing signal(s). That is, one or more sensing signals can be transmitted in multiple different transmit and/or repeater beams.

Likewise, in some aspects, the reflection of the sensing signal is received in multiple beams at the network node 200 and/or reflected/forwarded in multiple beams at the repeater node 300, 300a, 300b. In particular, in some embodiments, one occurrence of the at least one reflection signal is received in each beam in a first set of directional beams, and/or the repeater node 300, 300a, 300b is configured to receive one occurrence of the at least one reflection signal from the object 400, 400a, 400b in each beam in a second set of directional beams. Hence, multiple receive beams can be used by the network node 200 for receiving the sensing signal(s). That is, one or more sensing signals can be received in multiple different transmit and/or repeater beams.

In some aspects, the object 400, 400a, 400b is sensed by additional knowledge of the beam direction of the beams used to transmit the sensing signal and/or receive the reflection of the sensing signal. Therefore, in some embodiments, the at least one of: location, direction of movement, speed of movement, of the object 400, 400a, 400b is sensed using knowledge of beam direction used by the network node 200 and/or the repeater node 300, 300a, 300b for transmitting the at least one sensing signal and/or for receiving the at least one reflection signal. In some aspects, the network node 200 uses the estimated location of the object 400, 400a, 400b together with beam directions of the network node 200 and/or the repeater node 300, 300a, 300b to estimate the probability of that there is a line-of sight path between the object 400, 400a, 400b and the repeater node 300, 300a, 300b and/or between the object 400, 400a, 400b and the network node 200. Therefore, in some embodiments, whether there is a line-of-sight path between the network node 200 and the object 400, 400a, 400b or not is determined based on the sensed location of the object 400, 400a, 400b and knowledge of beam direction(s) used by the network node 200 and/or the repeater node 300, 300a, 300b for transmitting the at least one sensing signal and/or for receiving the at least one reflection signal.

In some embodiments, the network node 200 obtains repeater functionality-related information of the repeater node 300, 300a, 300b. Hence, in some embodiments, the network node 200 is configured to perform (optional) step S102.

S102: The network node 200 obtains a first report comprising repeater functionality-related information of the repeater node 300, 300a, 300b.

The first report might in S102 be obtained by received from the repeater node 300, 300a, 300b, possibly via one or more intermediate nodes, or from an operations, administration, and maintenance (OAM) system.

Information as obtained in the first report might then be taken into consideration when determining how to configure the repeater node 300, 300a, 300b for sensing the object 400, 400a, 400b.

In some embodiments, the repeater functionality-related information pertains to any, or any combination of: an indication that the repeater node 300, 300a, 300b is available to operate as a repeater, latency requirements, internal processing delay between wireless transmission and reception.

In some embodiments, the first report comprises an indication of the location of the repeater node 300, 300a, 300b. In other aspects, the network node 200 might retrieve information of the location of the repeater node 300, 300a, 300b from a table or from another network node, or by using cellular-based positioning techniques at the repeater node 300, 300a, 300b.

In some embodiments, the network node 200 obtains information indicating that the repeater node 300, 300a, 300b supports sensing. Hence, in some embodiments, the network node 200 is configured to perform (optional) step S104.

S104: The network node 200 obtains a second report indicating that the repeater node 300, 300a, 300b supports sensing.

The second report might in S104 be obtained by being received from the repeater node 300, 300a, 300b, possibly via one or more intermediate nodes, or from the OAM system.

Information as obtained in the second report might then be taken into consideration when determining how to configure the repeater node 300, 300a, 300b for sensing the object 400, 400a, 400b.

In some embodiments, the second report further indicates that the repeater node 300, 300a, 300b supports any of: single-polarized sensing, dual-polarized sensing, alternating polarization sensing.

In some embodiments, the second report further indicates any, or any combination of: switching delay between transmission and reception for sensing, accuracy of switching time between transmission and reception for sensing.

In some embodiments, the second report further indicates isolation between transmit and receiver antennas used for sensing.

In some embodiments, the second report further indicates any, or any combination of: support for single-direction sensing, support for dual-direction sensing. In this respect, support for single-direction sensing implies that the repeater node 300, 300a, 300b is capable of only reflects/forwards the sensing signal (or its reflection) in one direction, for example only in the downlink direction or only in the uplink direction, whereas support for dual-direction sensing implies that the repeater node 300, 300a, 300b is capable of reflecting/forwarding the sensing signal (or its reflection) both in the downlink direction and the uplink direction, using for example full duplex or quick switching. For dual-direction sensing, the capability can also indicate simultaneous downlink/uplink sensing using the same time and frequency allocation for downlink and uplink, i.e. support of full duplex sensing.

In some embodiments, the second report further indicates support of extra power boost for sensing. In this way, the network node 200 can configure the repeater node 300, 300a, 300b with power control to be used during the sensing.

In some embodiments, the second report further indicates beamforming capabilities for sensing, beam sweeping capabilities for sensing. Hence, the second report might indicate whether the repeater node 300, 300a, 300b is capable of generating wide beam for sensing, generating narrow beams for sensing, and/or performing beam sweep of narrow beams during sensing, or not.

In this way, information as obtained in the first report and/or information as obtained in the second report can help the network node 200 to properly configure the repeater node 300, 300a, 300b with sensing configurations in S106 which enables the proper sensing settings and the proper sensing actions to be made at the repeater node 300, 300a, 300b.

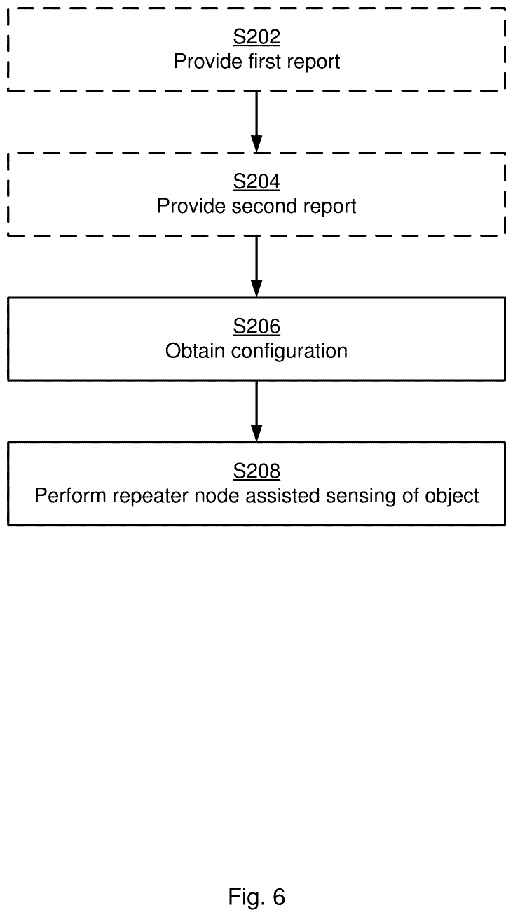

Reference is now made to FIG. 6 illustrating a method for performing repeater node assisted sensing of an object 400, 400a, 400b as performed by the repeater node 300, 300a, 300b according to an embodiment. In some embodiments, the repeater node 300, 300a, 300b is either a network-controlled repeater or a reconfigurable intelligent surface node.

S206: The repeater node 300, 300a, 300b obtains configuration, from a network node 200, for the sensing of the object 400, 400a, 400b.

S208: The repeater node 300, 300a, 300b performs the repeater node assisted sensing of the object 400, 400a, 400b by reflecting/forwarding at least one sensing signal, as wirelessly received from the network node 200, towards the object 400, 400a, 400b and/or reflecting/forwarding at least one reflection signal, as wirelessly received from the object 400, 400a, 400b, towards the network node 200.

In this way, the repeater node 300, 300a, 300b might aid the network node 200 to improve the sensing accuracy and avoid sensing holes where the network node 200 alone cannot properly sense the objects 400, 400a, 400b.

Embodiments relating to further details of performing repeater node assisted sensing of an object 400, 400a, 400b as performed by the repeater node 300, 300a, 300b will now be disclosed with continued reference to FIG. 6.

As disclosed above, in some embodiments, the configuration comprises one or more time resources for wireless transmission and/or reception. As disclosed above, in some embodiments, the configuration comprises time instances at which the repeater node 300, 300a, 300b is switched from reflecting/forwarding the at least one sensing signal towards the object 400, 400a, 400b to reflecting/forwarding the at least one reflection signal towards the network node 200, and/or time instances at which the repeater node 300, 300a, 300b is switched from reflecting/forwarding the at least one reflection signal towards the network node 200 to reflecting/forwarding the at least one sensing signal towards the object 400, 400a, 400b. Performing the repeater node assisted sensing in S208 might then comprise applying switching between reflecting/forwarding the at least one sensing signal towards the object 400, 400a, 400b and reflecting/forwarding the at least one reflection signal towards the network node 200 in accordance with the time instances (and with proper beam configuration).

As disclosed above, in some embodiments, the configuration comprises an indication of polarization to be used when reflecting/forwarding the at least one sensing signal towards the object 400, 400a, 400b and/or when reflecting/forwarding the at least one reflection signal towards the network node 200. Performing the repeater node assisted sensing in S208 might then comprise applying the indicated polarization when reflecting/forwarding the at least one sensing signal towards the object 400, 400a, 400b and/or when reflecting/forwarding the at least one reflection signal towards the network node 200.

As disclosed above, in some embodiments, the configuration comprises indication of a duplex mode in terms of one of time-division multiplexing, frequency-division multiplexing, space-division multiplexing. Performing the repeater node assisted sensing in S208 might then comprise applying the indicated duplex mode.

As disclosed above, in some aspects the at least one sensing signal is transmitted for multiple beams at the network node 200 and/or multiple beams at the repeater node 300, 300a, 300b. In this way, one or more sensing signals can be transmitted in multiple different beams at the network node 200 and/or the repeater node 300, 300a, 300b. That is, in some embodiments, one occurrence of the at least one sensing signal is by the repeater node 300, 300a, 300b reflected/forwarded towards the object 400, 400a, 400b in each beam in a second set of directional eams.

As disclosed above, in some aspects the at least one reflection of the sensing signal is received for multiple beams at the network node 200 and/or multiple beams at the repeater node 300, 300a, 300b. In this way, one or more reflections of the sensing signals can be received in multiple different beams at the network node 200 and/or the repeater node 300, 300a, 300b. That is, in some embodiments, one occurrence of the at least one reflection signal is by the repeater node 300, 300a, 300b reflected/received from the object 400, 400a, 400b in each beam in a second set of directional beams.

As disclosed above, in some embodiments, the network node 200 in S102 obtains a first report comprising repeater functionality-related information of the repeater node 300, 300a, 300b. In some embodiments, this first report is provided by the repeater node 300, 300a, 300b itself. Hence, in some embodiments, the repeater node 300, 300a, 300b is configured to perform (optional) step S202.

S202: The repeater node 300, 300a, 300b provides a first report towards the network node 200. The first report comprises repeater functionality-related information of the repeater node 300, 300a, 300b.

The first report might be sent using RRC signaling or MAC-CE signaling.

As disclosed above, in some embodiments, the repeater functionality-related information pertains to any, or any combination of: an indication that the repeater node 300, 300a, 300b is available to operate as a repeater, latency requirements, internal processing delay between wireless transmission and reception.

As further disclosed above, in some embodiments, the network node 200 in S104 obtains a second report indicating that the repeater node 300, 300a, 300b supports sensing. In some embodiments, this second report is provided by the repeater node 300, 300a, 300b itself. Hence, in some embodiments, the repeater node 300, 300a, 300b is configured to perform (optional) step S204.

S204: The repeater node 300, 300a, 300b provides a second report towards the network node 200. The second report indicates that the repeater node 300, 300a, 300b supports sensing.

The second report might be sent using RRC signaling or MAC-CE signaling.

As further disclosed above, in some embodiments, the second report further indicates that the repeater node 300, 300a, 300b supports any of: single-polarized sensing, dual-polarized sensing, alternating polarization sensing. For single-polarization, both the transmit and the receive antenna of the repeater node 300, 300a, 300b used for sensing is single-polarized. Here, the repeater node 300, 300a, 300b may support orthogonal polarizations for the transmit and the receive antennas where, for instance, the repeater node 300, 300a, 300b supports sensing using horizontal polarization for transmit and vertical polarization for receive, or vice versa. Alternatively, the repeater node 300, 300a, 300b may support sensing using linear +45 degrees polarization for transmit and -45 degrees polarization for receive, or vice versa. In another example, with support of single-polarized sensing, the repeater node 300, 300a, 300b may support sensing using the same polarizations for transmit and receive where, for instance, the repeater node 300, 300a, 300b supports sensing using horizontal, vertical, +45 degrees or -45 degrees polarization for both transmit and receive directions. Typically, using the same polarization for transmit and receive gives at least somewhat better detection possibility compared to using separate polarization for the transmit and receive directions. However, the isolation between the transmit and receive antennas increases when using orthogonal polarizations, which can impact full-duplex sensing. With the support of dual-polarized sensing, both the transmit antenna and the receive antenna of the repeater node 300, 300a, 300b used for sensing is dual-polarized. This will improve the diversity for the sensing. Finally, with the support of alternating polarization sensing, the transmit polarization and/or the receive polarization of the repeater node 300, 300a, 300b used for sensing can be dynamically changed. Typically, performing sensing with a first polarization will give different sensing results compared to performing sensing with a second polarization. Hence by performing sensing over two orthogonal polarizations, the diversity of the sensing can be improved leading to better detection capability/reliability and better general quality of the sensing.

As further disclosed above, in some embodiments, the second report further indicates any, or any combination of: switching delay between transmission and reception for sensing, accuracy of switching time between transmission and reception for sensing.

As further disclosed above, in some embodiments, the second report further indicates isolation between transmit and receiver antennas used for sensing.

As disclosed above, in some embodiments, the second report further indicates any, or any combination of: support for single-direction sensing, support for dual-direction sensing. Performing the repeater node assisted sensing in S208 might then comprise single-direction sensing or dual-direction sensing.

As disclosed above, in some embodiments, the second report further indicates support of extra power boost for sensing. Performing the repeater node assisted sensing in S208 might then comprise applying a configured amplification gain.

As disclosed above, in some embodiments, the second report further indicates any of: beamforming capabilities for sensing, beam sweeping capabilities for sensing. Performing the repeater node assisted sensing in S208 might then comprise applying a configured beamwidth.

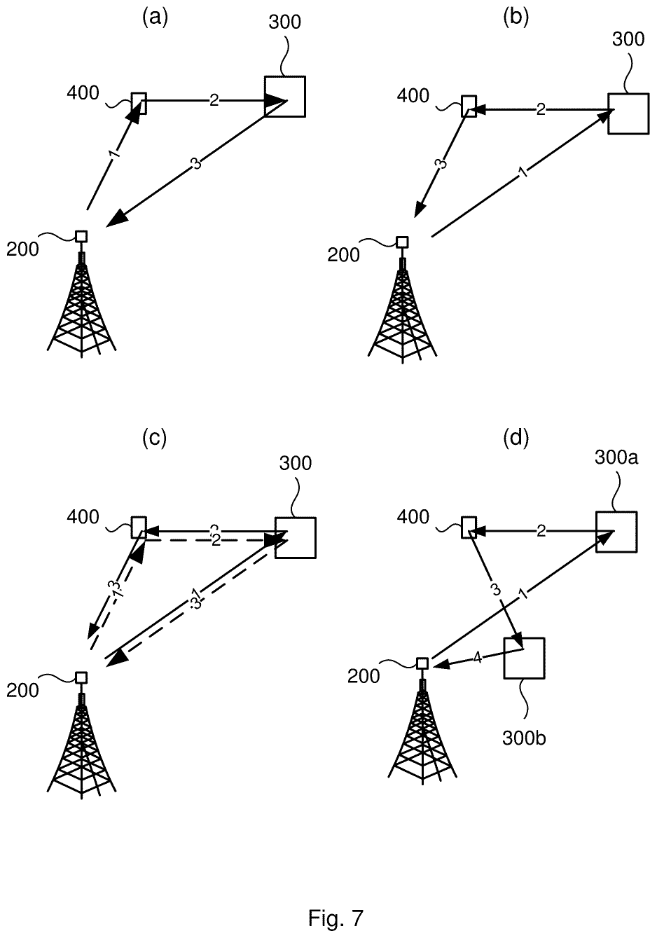

Examples applicable to the above disclosed embodiments for transmission and reception of sensing signals for sensing an object 400 will be provided next with reference to FIG. 7. In general terms, in FIG. 7(a), 7(b), 7(c), and 7(d) are shown four different examples of how sensing signals can be transmitted, received, reflected/forwarded to sense an object 400. The numbers “1”, “2”, “3”, and “4” illustrate the route a sensing signal takes from initially being transmitted by the network node 200 until it finally is received again by the network node 200 after being reflected/forwarded by the repeater node and reflected by the object 400 that is sensed.

In FIG. 7(a) is illustrated an example where the repeater node 300 is configured for UL operation. The sensing signal is by the network node transmitted towards the object 400. The sensing signal is then reflected by the object 400 towards the repeater node and reflected/forwarded by the repeater node 300 towards the network node 200. In this way, the sensing signal is thus transmitted towards the object 400 and, with a proper UL configuration of the repeater node 300, a reflection is received by the network node 200 through the repeater node 300.

In FIG. 7(b) is illustrated an example where the repeater node 300 is configured for DL operation. The sensing signal is by the network node transmitted towards the repeater node 300. The sensing signal is then reflected/forwarded by the repeater node 300 towards the object 400. The sensing signal is then reflected by the object 400 towards the network node 200. In this way, the sensing signal is thus transmitted towards the repeater node 300, which with proper DL configuration, reflects/forwards the sensing signal towards the object 400 where the sensing signal is reflected back towards the network node 200.

In FIG. 7(c) is illustrated an example where the repeater node 300 is configured for both DL operation and UL operation. A first occurrence of the sensing signal is by the network node transmitted towards the object 400. A second occurrence of the sensing signal is by the network node 200 transmitted towards the repeater node 300. The first occurrence of the sensing signal follows the same route as the sensing signal in FIG. 7(b). The second occurrence of the sensing signal follows the same route as the sensing signal in FIG. 7(a). In this way, in case the repeater node 300 is configured for simultaneous UL and DL operation, the first occurrence and the second occurrence of the sensing signal can be simultaneously transmitted from the network node 200.

In FIG. 7(d) is illustrated an example where a first repeater node 300a is configured for DL operation and a second repeater node 300b is configured for UL operation. The sensing signal is by the network node transmitted towards the first repeater node 300a. The sensing signal is then reflected/forwarded by the first repeater node 300a towards the object 400. The sensing signal is then reflected by the object 400 towards the second repeater node 300b. The sensing signal is then reflected/forwarded by the second repeater node 300b towards the network node 200. In this way, the first repeater node 300a is configured as the repeater node 300 in FIG. 7(b) whereas the second repeater node 300b is configured as the repeater node 300 in FIG. 7(a); the first repeater node 300a and the second repeater node 300b do not need to be aware of each other but their operation is coordinated by the network node 200.

The setup in FIG. 7(d) can be extended to multiple repeater nodes where the sensing accuracy is improved by the number of repeater nodes.

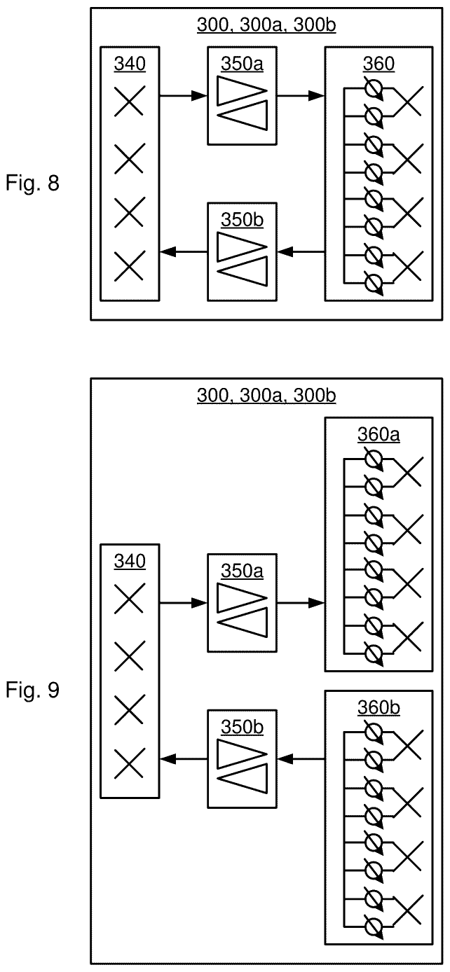

Different examples of repeater nodes 300, 300a, 300b will be disclosed next with reference to FIGS. 8, 9, and 10. The repeater node 300, 300a, 300b comprises a first antenna array, or panel, 340 for communication over wireless link 120 and one or more second antenna arrays 360, 360a, 360b, 360c, or panels, for communication over wireless link 130. The first antenna array, or panel, 340 is operatively connected to the one or more second antenna arrays 360, 360a, 360b, 360c, or panels, via circuitry 350a, 350b which might comprise one or more transceivers, amplifiers, etc. depending on the configuration of the repeater nodes 300, 300a, 300b.

FIG. 8 illustrates one example of a repeater node 300, 300a, 300b configured for full duplex sensing using a first polarization for the transmit antenna used for the sensing and a second polarization for the receive antenna used for sensing. Sensing is possible both when using same polarization of transmit and receive antennas as when using orthogonal polarizations of transmit and receive antennas. In further detail, the antenna elements of the first antenna array, or panel, 340 with a first polarization is operatively connected via the circuitry 350a to the antenna elements of the second antenna array, or panel, 360 with the same polarization as the first polarization, and the antenna elements of the first antenna array, or panel, 340 with a second polarization is operatively connected via the circuitry 350b to the antenna elements of the second antenna array, or panel, 360 with the same polarization as the second polarization.

FIG. 9 illustrates one example of a repeater node 300, 300a, 300b supporting sensing with alternating polarization, i.e., where the polarization of the transmit antenna and receive antenna used for the sensing can be dynamically updated (alternated) by changing the phase shifter settings of the phase shifters associated with the different antenna elements of a respective antenna panel. In some examples, a static configuration is used for this architecture where the same polarization is used for the transmitter antenna and the receiver antenna. For example, both antenna array, or panel, 360a and antenna array, or panel, 360b can be configured with the same resulting polarization. In some examples, this configuration is used for full duplex sensing, e.g., where DL forwarding is used for antenna array, or panel, 360a and UL forwarding is simultaneously used for antenna array, or panel, 360b. One advantage with full duplex sensing is that it does not require quick and precise switching between DL and UL operation of the repeater node 300, 300a, 300b. In further detail, the antenna elements of the first antenna array, or panel, 340 with a first polarization is operatively connected via the circuitry 350a to the antenna elements of the second antenna arrays, or panels, 360a, 360b with the same polarization as the first polarization, and the antenna elements of the first antenna array, or panel, 340 with a second polarization is operatively connected via the circuitry 350b to the antenna elements of the second antenna arrays, or panels, 360a, 360b with the same polarization as the second polarization.

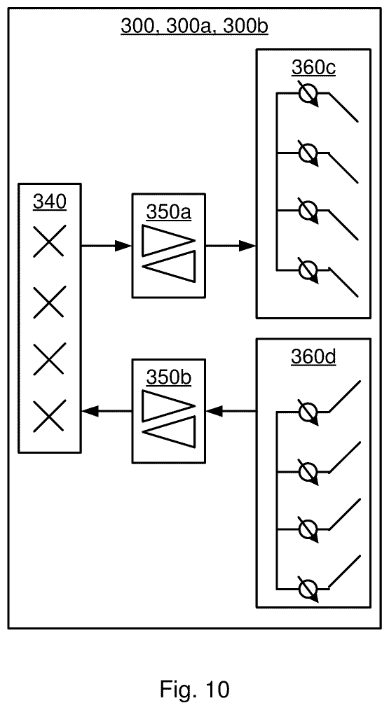

FIG. 10 illustrates one embodiment of a repeater node 300, 300a, 300b supporting single polarized sensing with orthogonal polarizations between the transmitter antennas and the receiver antennas, i.e., where the transmit antennas used for the sensing have a first polarization and the receive antenna used for the sensing have another, second, polarization, where the polarization is orthogonal for the transmit and the receive antennas. In some examples, this configuration is used for full duplex sensing, i.e., both the DL path and the UL are used simultaneously. For example, antenna array, or panel, 360c can be used for DL forwarding and simultaneously antenna array, or panel, 360d can be used for UL forwarding. One benefit with using orthogonal polarizations for the transmit and receive antennas is that the isolation between the antenna panels will be reduced compared to using the same polarization for both antenna panels. In the example of FIG. 10, the antennas of the two polarizations are also separated in space to increase the isolation between the transmitter and the receiver used for sensing even further. In further detail, the antenna elements of the first antenna array, or panel, 340 with a first polarization is operatively connected via the circuitry 350a to the antenna elements of the second antenna array, or panel, 360c with the same polarization as the first polarization, and the antenna elements of the first antenna array, or panel, 340 with a second polarization is operatively connected via the circuitry 350b to the antenna elements of the second antenna array, or panel, 360d with the same polarization as the second polarization.

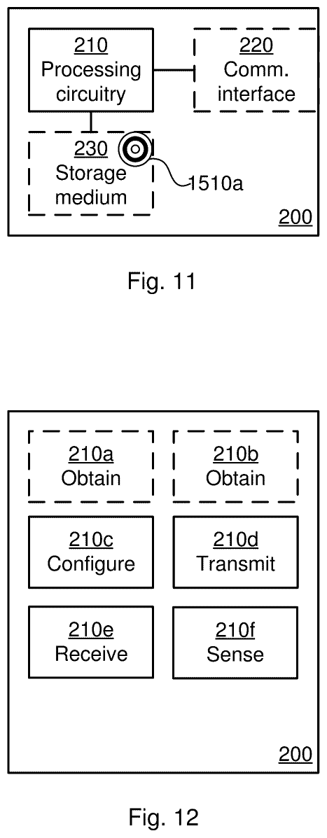

FIG. 11 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1510a (as in FIG. 15), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The network node 200 may further comprise a communications (comm.) interface 220 for communications with other entities, functions, nodes, and devices, in accordance with the above-disclosed embodiments. As such the communications interface 220 may comprise one or more transmitters and receivers, comprising analogue and digital components.

The processing circuitry 210 controls the general operation of the network node 200 e.g. by sending data and control signals to the communications interface 220 and the storage medium 230, by receiving data and reports from the communications interface 220, and by retrieving data and instructions from the storage medium 230.

Other components, as well as the related functionality, of the network node 200 are omitted in order not to obscure the concepts presented herein.

FIG. 12 schematically illustrates, in terms of a number of functional modules, the components of a network node 200 according to an embodiment. The network node 200 of FIG. 12 comprises a number of functional modules; a configure module 210c configured to perform step S106, a transmit module 210d configured to perform step S108, a receive module 210e configured to perform step S110, and a sense module 210f configured to perform step S112. The network node 200 of FIG. 12 may further comprise a number of optional functional modules, such as any of an obtain module 210a configured to perform step S102, and an obtain module 210b configured to perform step S104. In general terms, each functional module 210a:210f may be implemented in hardware or in software. Preferably, one or more or all functional modules 210a:210f may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210f and to execute these instructions, thereby performing any steps of the network node 200 as disclosed herein.

The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 11 the processing circuitry 210 may be distributed among a plurality of devices, or nodes. The same applies to the functional modules 210a:210f of FIG. 12 and the computer program 1520a of FIG. 15.

Some (radio) access network architectures define network nodes (or gNBs) comprising multiple component parts or nodes: a central unit (CU), one or more distributed units (DUs), and one or more radio units (RUs). The protocol layer stack of the network node is divided between the CU, the DUs and the RUs, with one or more lower layers of the stack implemented in the RUs, and one or more higher layers of the stack implemented in the CU and/or DUs. The CU is coupled to the DUs via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200 in the downlink (i.e., from the CU to the RU) or received by the network node 200 in the uplink (i.e., from the RU to the CU).

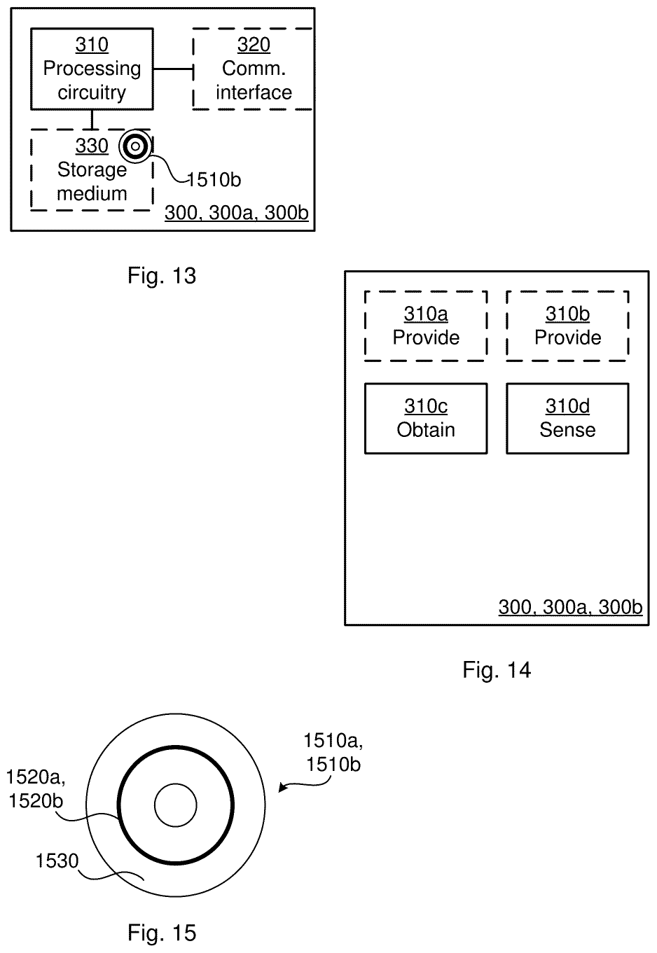

FIG. 13 schematically illustrates, in terms of a number of functional units, the components of a repeater node 300, 300a, 300b according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1510b (as in FIG. 15), e.g. in the form of a storage medium 330. The processing circuitry 310 may further be provided as at least one application specific integrated circuit (ASIC), or field programmable gate array (FPGA).

Particularly, the processing circuitry 310 is configured to cause the repeater node 300, 300a, 300b to perform a set of operations, or steps, as disclosed above. For example, the storage medium 330 may store the set of operations, and the processing circuitry 310 may be configured to retrieve the set of operations from the storage medium 330 to cause the repeater node 300, 300a, 300b to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The repeater node 300, 300a, 300b may further comprise a communications interface 320 for communications with other entities, functions, nodes, and devices, in accordance with the above-disclosed embodiments. As such the communications interface 320 may comprise one or more transmitters and receivers, comprising analogue and digital components.

The processing circuitry 310 controls the general operation of the repeater node 300, 300a, 300b e.g. by sending data and control signals to the communications interface 320 and the storage medium 330, by receiving data and reports from the communications interface 320, and by retrieving data and instructions from the storage medium 330. Other components, as well as the related functionality, of the repeater node 300, 300a, 300b are omitted in order not to obscure the concepts presented herein.

FIG. 14 schematically illustrates, in terms of a number of functional modules, the components of a repeater node 300, 300a, 300b according to an embodiment. The repeater node 300, 300a, 300b of FIG. 14 comprises a number of functional modules; an obtain module 310c configured to perform step S206, and a sense module 310d configured to perform step S208. The repeater node 300, 300a, 300b of FIG. 14 may further comprise a number of optional functional modules, such as any of a provide module 310a configured to perform step S102, and a provide module 310b configured to perform step S204. In general terms, each functional module 310a:310d may be implemented in hardware or in software. Preferably, one or more or all functional modules 310a:310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310d and to execute these instructions, thereby performing any steps of the repeater node 300, 300a, 300b as disclosed herein.

FIG. 15 shows one example of a computer program product 1510a, 1510b comprising computer readable means 1530. On this computer readable means 1530, a computer program 1520a can be stored, which computer program 1520a can cause the processing circuitry 210 and thereto operatively coupled entities and devices, such as the communications interface 220 and the storage medium 230, to execute methods according to embodiments described herein. The computer program 1520a and/or computer program product 1510a may thus provide means for performing any steps of the network node 200 as herein disclosed. On this computer readable means 1530, a computer program 1520b can be stored, which computer program 1520b can cause the processing circuitry 310 and thereto operatively coupled entities and devices, such as the communications interface 320 and the storage medium 330, to execute methods according to embodiments described herein. The computer program 1520b and/or computer program product 1510b may thus provide means for performing any steps of the repeater node 300, 300a, 300b as herein disclosed.

In the example of FIG. 15, the computer program product 1510a, 1510b is illustrated as an optical disc, such as a CD (compact disc) or a DVD (digital versatile disc) or a Blu-Ray disc. The computer program product 1510a, 1510b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1520a, 1520b is here schematically shown as a track on the depicted optical disk, the computer program 1520a, 1520b can be stored in any way which is suitable for the computer program product 1510a, 1510b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for performing repeater node assisted sensing of an object, wherein the method is performed by a network node and wherein the method comprises:
configuring a repeater node for the sensing of the object; and
wirelessly transmitting at least one sensing signal, wherein the at least one sensing signal is transmitted towards the object and/or towards the repeater node (300, for being reflected towards the object
wirelessly receiving at least one reflection signal, wherein the at least one reflection signal is a reflection of the at least one sensing signal as reflected at the object, wherein the at least one reflection signal is received from the repeater node when the at least one sensing signal was transmitted towards the object or when the at least one sensing signal was transmitted towards the repeater node, and wherein the at least one reflection signal is received from the object when the at least one sensing signal was transmitted towards the repeater node; and
sensing at least one of: location, direction of movement, speed of movement, of the object by processing the at least one reflection signal.

2. The method according to claim 1, wherein configuring the repeater node comprises configuring the repeater node with one or more time resources for wireless transmission and/or reception.

3. The method according to claim 1, wherein configuring the repeater node comprises configuring the repeater node for at least one of: reflecting/forwarding the at least one sensing signal towards the object, reflecting/forwarding the at least one reflection signal towards the network node

4. The method according to claim 1, wherein configuring the repeater node comprises indicating time instances at which the repeater node is switched from reflecting/forwarding the at least one sensing signal towards the object to reflecting/forwarding the at least one reflection signal towards the network node, and/or indicating time instances at which the repeater node is switched from reflecting/forwarding the at least one reflection signal towards the network node to reflecting/forwarding the at least one sensing signal towards the object.

5. The method according to claim 1, wherein configuring the repeater node comprises indicating polarization to be used when reflecting/forwarding the at least one sensing signal towards the object and/or when reflecting/forwarding the at least one reflection signal towards the network node.

6. The method according to claim 1, wherein at least two sensing signals are wirelessly transmitted.

7. The method according to claim 6, wherein the at least two sensing signals are multiplexed using any of: time-division multiplexing, frequency-division multiplexing, space-division multiplexing.

8. The method according to claim 1, wherein one occurrence of the at least one sensing signal is transmitted in each beam in a first set of directional beams, and/or wherein the repeater node is configured to reflect/forward one occurrence of the at least one sensing signal towards the object in each beam in a second set of directional beams.

9. The method according to claim 1, wherein one occurrence of the at least one reflection signal is received in each beam in a first set of directional beams, and/or wherein the repeater node is configured to reflect/receive one occurrence of the at least one reflection signal from the object in each beam in a second set of directional beams.

10. The method according to claim 8 wherein said at least one of: location, direction of movement, speed of movement, of the object is sensed using knowledge of beam direction used by the network node and/or the repeater node for transmitting the at least one sensing signal and/or for receiving the at least one reflection signal.

11. The method according to claim 8, wherein whether there is a line-of-sight path between the network node and the object or not is determined based on the sensed location of the object and knowledge of beam direction used by the network node and/or the repeater node for transmitting the at least one sensing signal and/or for receiving the at least one reflection signal.

12. The method according to claim 1, wherein the method further comprises:
obtaining a first report comprising repeater functionality-related information of the repeater node.

13. The method according to claim 12, wherein the repeater functionality-related information pertains to any, or any combination of: an indication that the repeater node is available to operate as a repeater, latency requirements, internal processing delay between wireless transmission and reception.

14. The method according to claim 1, wherein the method further comprises:
obtaining a second report indicating that the repeater node supports sensing.

15. The method according to claim 14, wherein the second report further indicates that the repeater node supports any of: single-polarized sensing, dual-polarized sensing, alternating polarization sensing, and/or wherein the second report further indicates any, or any combination of: switching delay between transmission and reception for sensing, accuracy of switching time between transmission and reception for sensing, and/or wherein the second report further indicates isolation between transmit and receiver antennas used for sensing, and/or wherein the second report further indicates any, or any combination of: support for single-direction sensing, support for dual-direction sensing, and/or wherein the second report further indicates support of extra power boost for sensing, and/or wherein the second report further indicates beamforming capabilities for sensing, beam sweeping capabilities for sensing.

16. The method according to claim 1, wherein the repeater node is either a network-controlled repeater or a reconfigurable intelligent surface node.

17. A method for performing repeater node assisted sensing of an object, wherein the method is performed by a repeater node, and wherein the method comprises:
obtaining configuration, from a network node, for the sensing of the object;
performing the repeater node assisted sensing of the object by reflecting/forwarding at least one sensing signal, as wirelessly received from the network node, towards the object and/or reflecting/forwarding at least one reflection signal, as wirelessly received from the object, towards the network node

18. The method according to claim 17, wherein the configuration comprises one or more time resources for wireless transmission and/or reception.

19. The method according to claim 17, wherein the configuration comprises time instances at which the repeater node is switched from reflecting/forwarding the at least one sensing signal towards the object to reflecting/forwarding the at least one reflection signal towards the network node, and/or time instances at which the repeater node is switched from reflecting/forwarding the at least one reflection signal towards the network node to reflecting/forwarding the at least one sensing signal towards the object.

20. The method according to claim 19, wherein performing the repeater node assisted sensing comprises applying switching between reflecting/forwarding the at least one sensing signal towards the object and reflecting/forwarding the at least one reflection signal towards the network node in accordance with the time instances.

21-40. (canceled)
